(19) United States
(12) Patent Application Publication
(10) Pub. No.: US 2020/0139520 A1
(43) Pub. Date: May 7, 2020

(54) FLUID-POWERED TORQUE WRENCH WITH FLUID PUMP CONTROLS

(71) Applicant: Actuant Corporation, Menomonee Falls, WI (US)

(72) Inventors: Barry Fallon, Kings Heath (GB); Tom Foley, Bilston (GB); Tyler Jeffrey Johnson, Ripon, WI (US); Niklas Linn Olson, Antigo, WI (US); Luke Wesley Waddingham, Milwaukee, WI (US)

(21) Appl. No.: 16/735,309

(22) Filed: Jan. 6, 2020

Related U.S. Application Data
(63) Continuation-in-part of application No. 15/584,819, filed on May 2, 2017.
(60) Provisional application No. 62/330,617, filed on May 2, 2016.

(51) Int. Cl. B25B 21/00

(52) U.S. Cl. CPC B25B 21/002; B25B 21/005

(57) ABSTRACT

A control assembly, a tool and a method. The assembly may include a handle assembly including a first handle portion and a second handle portion, the handle assembly being removably connectable to a tool housing; and pump controls operable to control a pump to drive a tool drive mechanism and thereby an output member. Operation of the pump may require an operator's first hand on a first handle portion and the operator's second hand on a second handle portion. The pump may be operable under the control of the pump controls to drive the drive mechanism when the handle assembly is connected to the housing and when the handle assembly is disconnected from the housing.

### RELATED APPLICATIONS

The present application is a continuation-in-part of and claims priority to co-pending U.S. patent application Ser. No. 15/584,819, filed May 2, 2017, which claims the benefit of U.S. Provisional Patent Application No. 62/330,617, filed May 2, 2016, and is related to U.S. Design patent application Ser. No. 29/563,103, filed May 2, 2016, the entire contents of all of which are hereby incorporated by reference.

### FIELD

The present invention relates to a tool, s as a fluid-powered torque wrench, and, more particularly, to such a tool in which the controls require two-hand operation.

### SUMMARY

Fluid-powered wrenches designed for the transmission of rotational power to threaded fasteners are widely used tools in industry. There are a variety of different types of power wrenches, but one typical wrench design consists of a fluid-driven, reciprocating piston driving a socket. These reciprocating piston-style torque wrenches are commonly used in flange bolting operations due to their compact nature.

With reciprocating piston-style torque wrenches, a fluid pump is coupled to the wrench via a hose to drive the piston. The pump is typically actuated via controls located on the pump or coupled to the pump via a pendant.

In operation, it is common to use two technicians to operate this style of wrench. One technician positions the wrench on the nut to be tightened. Once in position and clear of pinch points, that technician communicates to the other technician to operate the pump to actuate the wrench. Miscommunication may result undesirable operations, especially for the first technician.

Thus, a need may exist to allow a single technician to operate a reciprocating piston-style fluid-operated torque wrench. Some much larger electronic, motor-driven torque wrenches (sometimes called torque multipliers) allow for this, but such operation is not known for the much more compact piston-style fluid-operated torque wrenches.

A further need may exist to have such a reciprocating piston-style fluid-operated torque wrench that can also remain compact.

In one independent aspect, a reciprocating piston-style torque wrench having pump controls coupled to the torque wrench may be provided. In some embodiments, the pump controls may be selectively coupled to the torque wrench to allow the wrench to fit into tight areas while keeping the controls adjacent the wrench.

In another independent aspect, a handle with pump controls may be coupled to a fluid operated, reciprocating piston style torque wrench. In some embodiments, the handle may be selectively coupled to the wrench to allow the wrench to fit into tight areas.

In yet another independent aspect, a handle with pump controls may be coupled to the reciprocating piston-style torque wrench, wherein the handle requires two-hand operation.

In one particular independent embodiment, a fluid-operated, reciprocating piston-style torque wrench having fluid pump controls selectively coupled to the torque wrench may be provided. The wrench may further include a handle housing the pump controls, the handle being selectively coupled to the torque wrench. The handle may include a first grasping location and a second grasping location, wherein the wrench cannot be operated unless an operator's hands are on both grasping locations. The handle may further include a first actuator located adjacent the first grasping location and a second actuator located adjacent the second grasping location and wherein the wrench cannot operate unless both actuators are actuated.

In a further independent embodiment, a control assembly for a fluid-operated, reciprocating piston-style torque wrench may be provided. The wrench may include a housing, and a reciprocating drive mechanism supported by the housing, the drive mechanism being selectively-driven by a fluid pump and operable to drive an output member. The assembly may generally include a body connectable to the housing; a first handle and a second handle connected to the body; a first sensor operable to sense an operator's first hand on the first handle; and a second sensor operable to sense the operator's second hand on the second handle. Operation of the pump may require sensing the operator's first hand on the first handle while sensing the operator's second hand on the second handle.

In another independent embodiment, a torque wrench may generally include a housing; a reciprocating drive mechanism supported by the housing, the drive mechanism being selectively-driven by a fluid pump and operable to drive an output member; and a control assembly. The control assembly may include a body connected to the housing, a first handle and a second handle connected to the body, and pump controls operable to control the pump to drive the drive mechanism and thereby the output member. The pump controls may include a first pump control supported proximate the first handle, the first pump control being operable by a digit of a first hand of an operator gripping the first handle, and a second pump control supported proximate the second handle, the second pump control being operable by a digit of a second hand of the operator on the second handle. The pump may be operable upon operation of the first pump control and the second pump control.

In yet another independent embodiment, a method of operating a fluid-operated, reciprocating piston-style torque wrench may be provided. The wrench may include a housing, and a reciprocating drive mechanism supported by the housing and operable to drive an output member. The method may generally include providing a control assembly connected to the housing_{;} the control assembly including a body connected to the housing and a first handle and a second handle connected to the body; positioning the output member relative to a fastener to be adjusted; and after positioning, operating a fluid pump to drive the drive mechanism and thereby the output member to adjust the fastener, operating including sensing the operator's first hand on the first handle while sensing the operator's second hand on the second handle.

In a further independent embodiment, a control assembly for a fluid-operated tool may be provided. The tool may include a housing, and a drive mechanism supported by the housing, the drive mechanism being selectively-driven by a fluid pump and operable to drive an output member. The control assembly may include a handle assembly removably connected to the housing and pump controls operable to control the pump to drive the drive mechanism and thereby the output member. The handle assembly may include a first handle portion and a second handle portion. The pump controls may include a first pump control operable by a digit of an operator's first hand on the first handle portion, the first pump control being in communication with the pump when the handle assembly is connected to the housing and when the handle assembly is disconnected from the housing, and a second pump control operable by a digit of the operator's second hand on the second handle portion, the second pump control being in communication with the pump when the handle assembly is connected to the housing and when the handle assembly is disconnected from the housing. Operation of the pump may require the operator's first hand on the first handle portion and the operator's second hand on the second handle portion. The pump may be operable under the control of the pump controls to drive the drive mechanism when the handle assembly is connected to the housing and when the handle assembly is disconnected from the housing.

In another independent embodiment, a tool may be provided. The tool may include a housing, a drive mechanism supported by the housing, the drive mechanism being selectively-driven by a fluid pump and operable to drive an output member, and a control assembly. The control assembly may include a handle assembly removably connectable to the housing and pump controls operable to control the pump to drive the drive mechanism and thereby the output member, the pump controls being in communication with the pump when the handle assembly is connected to the housing and when the handle assembly is disconnected from the housing. The handle assembly may include a first handle portion and a second handle portion. The pump controls may include a first pump control supported proximate the first handle portion, the first pump control being operable by a digit of a first hand of an operator gripping the first handle portion and a second pump control supported proximate the second handle portion, the second pump control being operable by a digit of a second hand of the operator on the second handle portion. Operation of the pump may require the operator's first hand on the first handle portion and the operator's second hand on the second handle portion. The pump may be operable under the control of the pump controls to drive the drive mechanism when the handle assembly is connected to the housing and when the handle assembly is disconnected from the housing.

In yet another independent embodiment, a method of operating a fluid-operated tool may be provided. The tool may include a housing and a drive mechanism supported by the housing and operable to drive an output member. The method may generally include providing a control assembly including a handle assembly separate from the housing, the handle assembly including a first handle portion and a second handle portion; selectively and alternatively releasably connecting the handle assembly to the housing and disconnecting the handle assembly from the housing; positioning the output member relative to a fastener to be adjusted; when the handle assembly is connected to the housing, after positioning, operating a fluid pump to drive the drive mechanism and thereby the output member, operating including sensing the operator's first hand on the first handle portion while sensing the operator's second hand on the second handle portion; and, when the handle assembly is disconnected from the housing, after positioning, operating the fluid pump to drive the drive mechanism and thereby the output member, operating including sensing the operator's first hand on the first handle portion while sensing the operator's second hand on the second handle portion.

Other independent aspects, features and/or advantages of the invention may become apparent to those skilled in the art upon review of the detailed description, claims and drawings.

BRIEF DESCRIPTION OF THE DRAWINGS

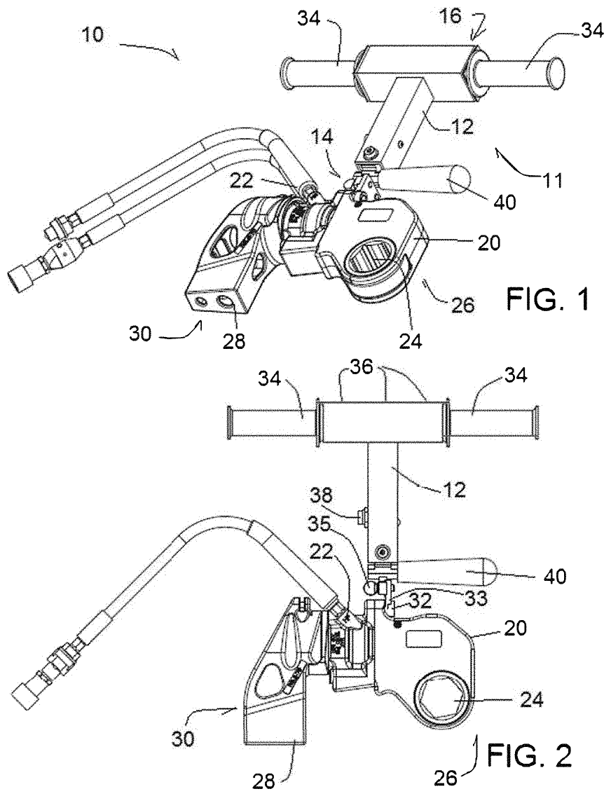

FIG. 1 is a perspective view of one independent embodiment of a reciprocating piston fluid-operated torque wrench having integrated controls.

FIG. 2 is a top view of the wrench and control assembly of FIG. 1.

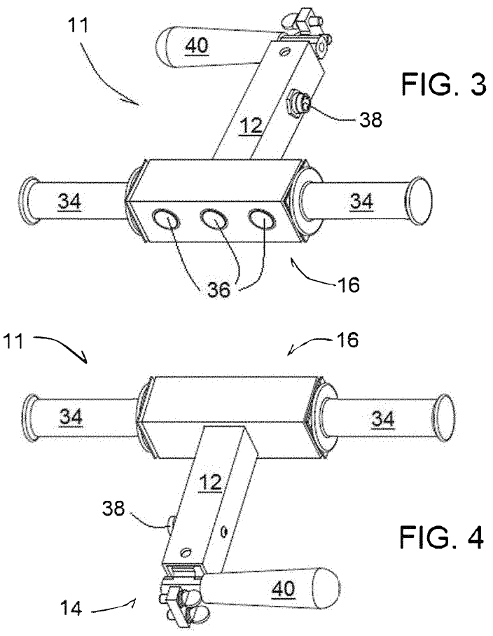

FIG. 3 is a first perspective view of the control assembly of FIG. 1.

FIG. 4 is a second perspective view of the control assembly of FIG. 1.

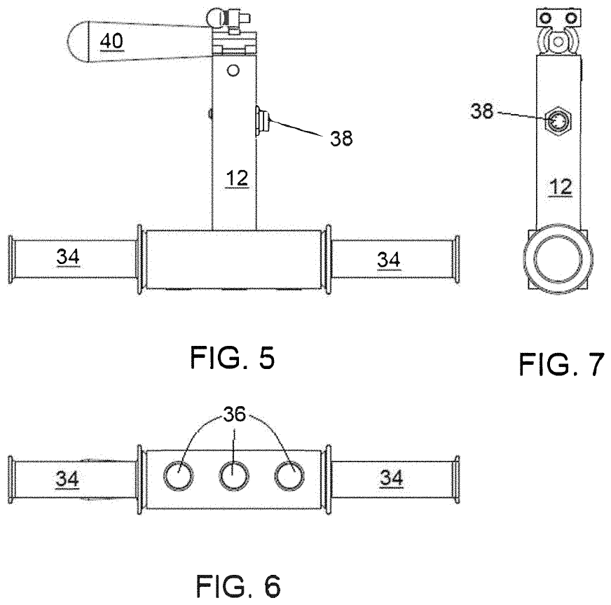

FIG. 5 is a top view of the control assembly of FIG. 1.

FIG. 6 is a front view of the control assembly of FIG. 1.

FIG. 7 is a side view of the control assembly of FIG. 1.

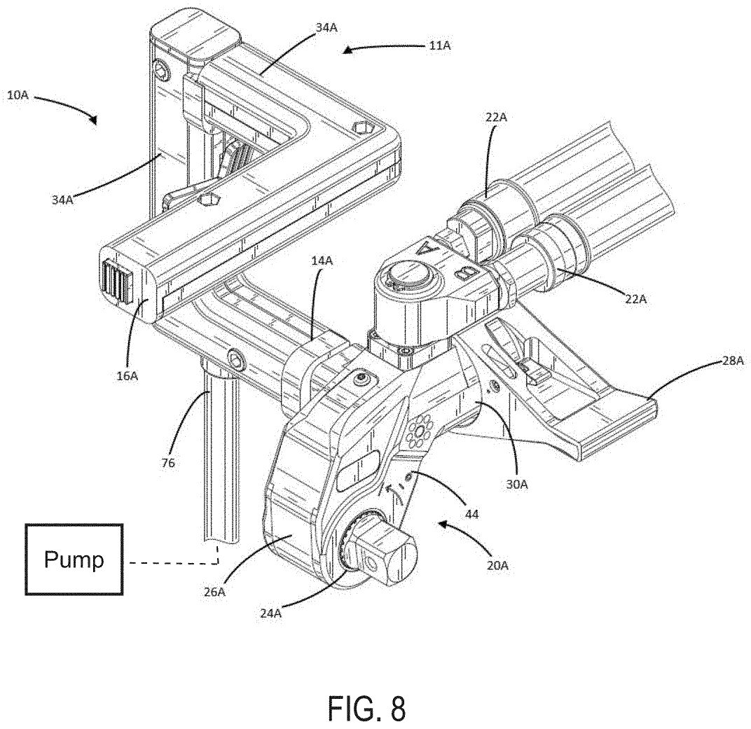

FIG. 8 is a perspective view of an alternative embodiment of a tool, such as a reciprocating piston fluid-operated torque wrench, having integrated controls,

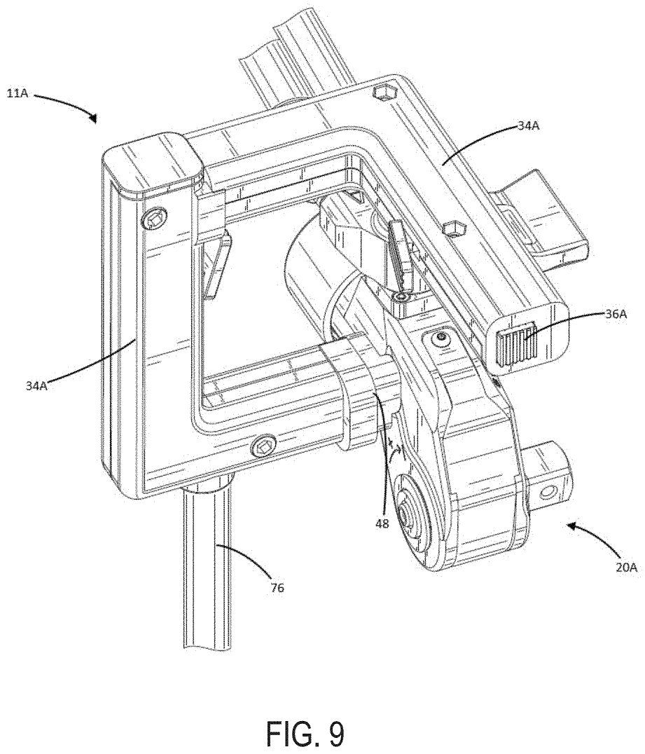

FIG. 9 is another perspective view of the tool and the control assembly of FIG. 8.

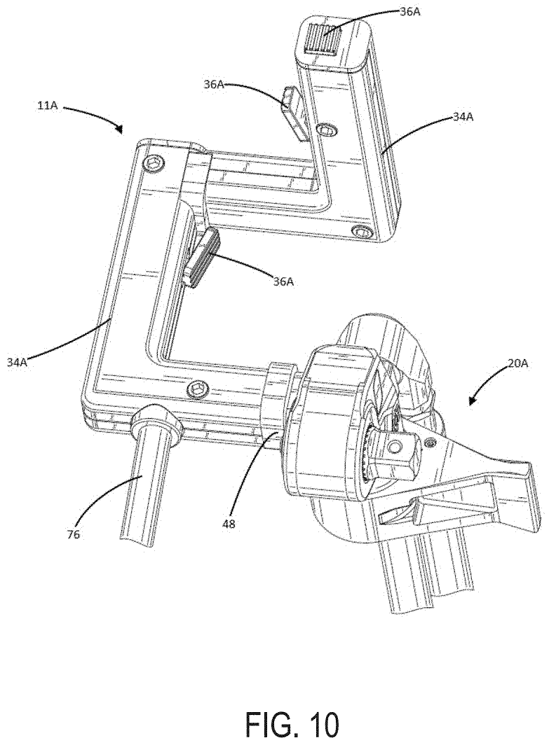

FIG. 10 is yet another perspective view of the tool and the control assembly of FIG. 8.

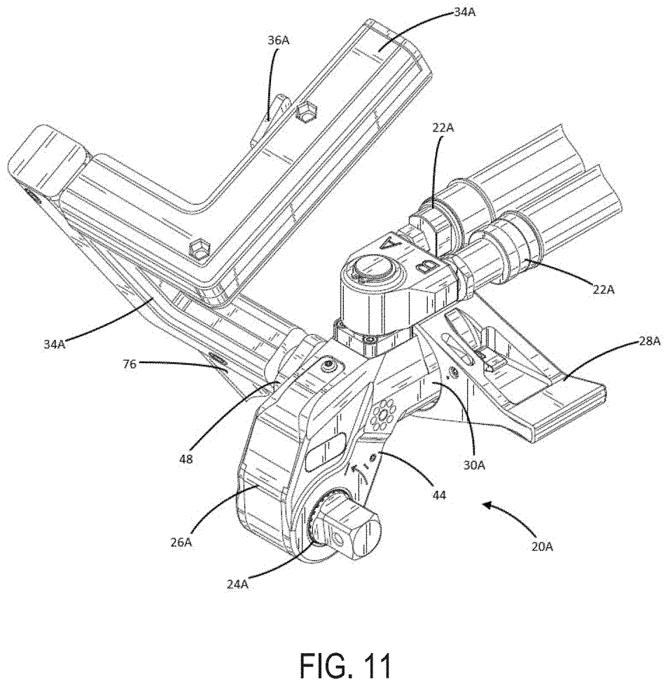

FIG. 11 is a further perspective view of the tool and the control assembly of FIG. 8, illustrating different pivoted positions of the control assembly and the handle portions.

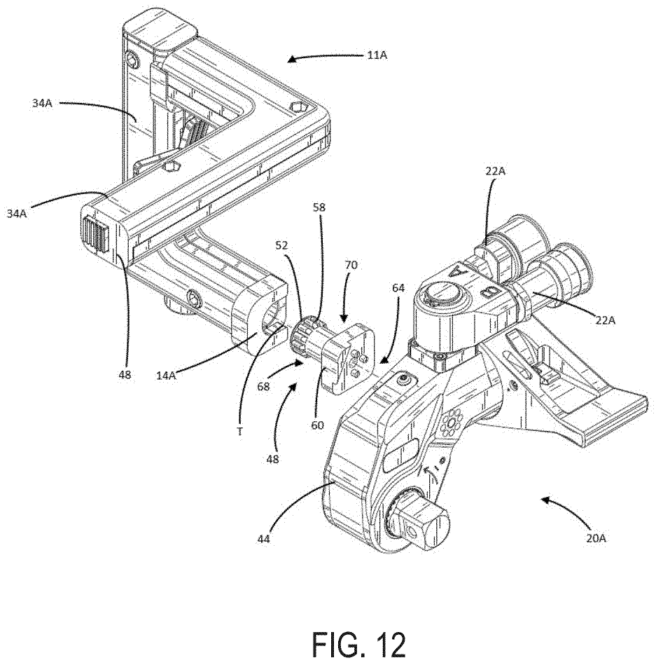

FIG. 12 is a fourth perspective view of the tool and the control assembly of FIG. 8, illustrating the tool, the control assembly and an adapter as separate components.

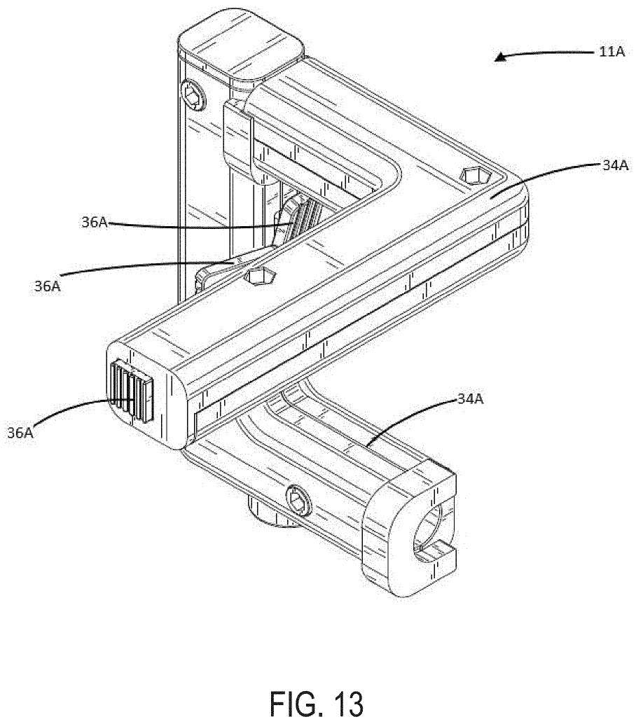

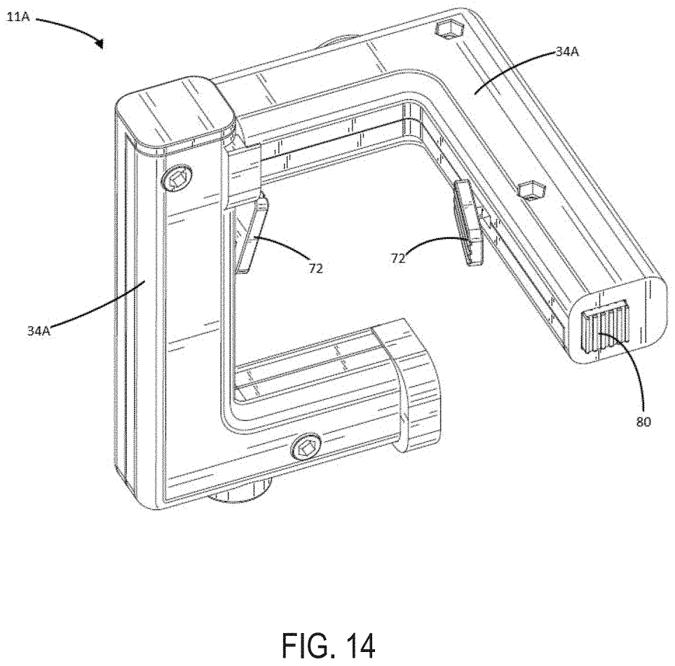

FIG. 13 is a perspective view of the handle assembly of FIG. 12.

FIG. 14 is another perspective view of the handle assembly of FIG. 13.

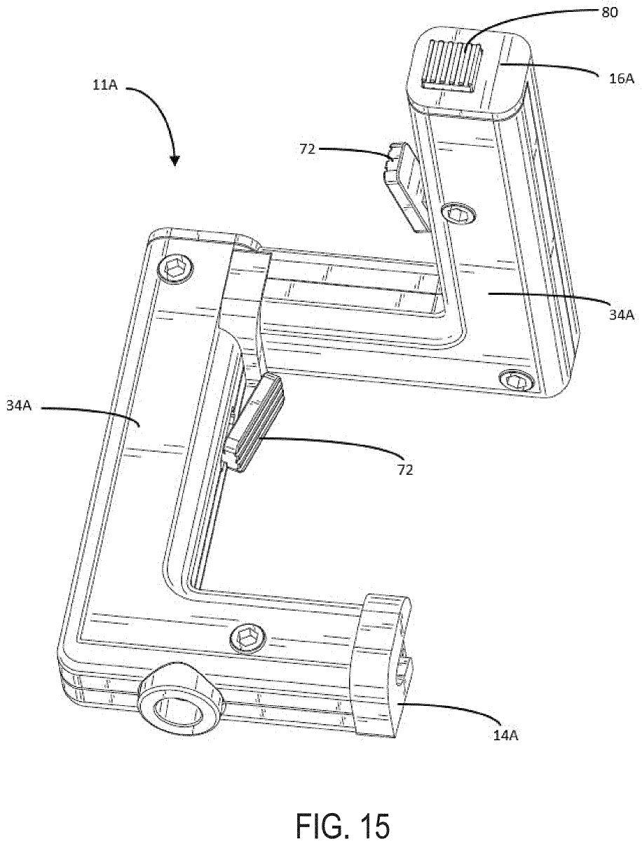

FIG. 15 is yet another perspective view of the handle assembly of FIG. 13.

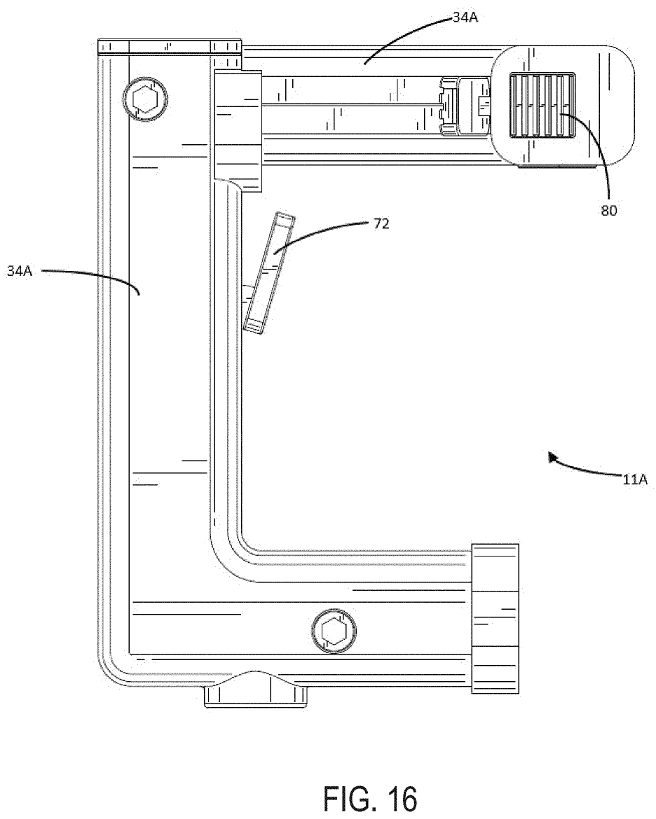

FIG. 16 is a front view of the handle assembly of FIG. 13.

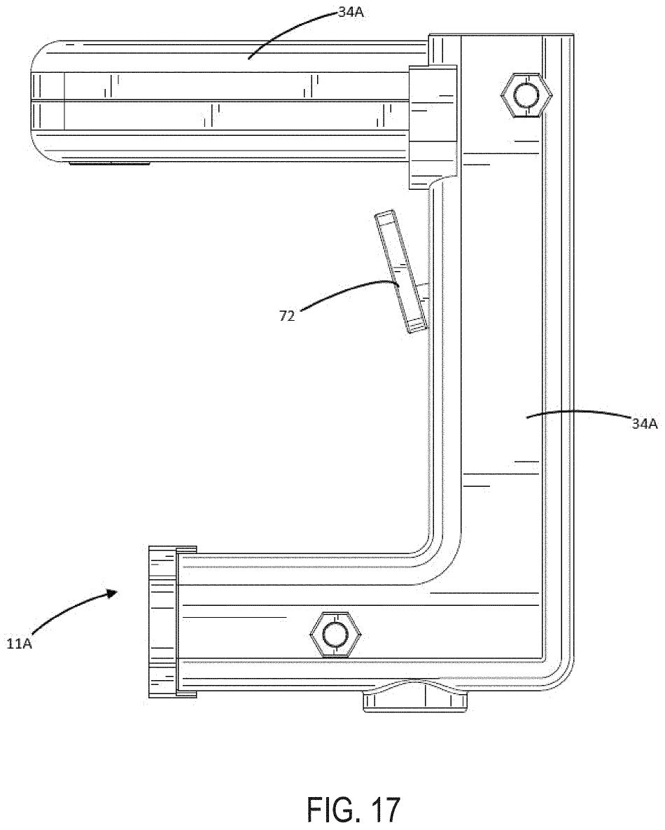

FIG. 17 is a rear view of the handle assembly of FIG. 13.

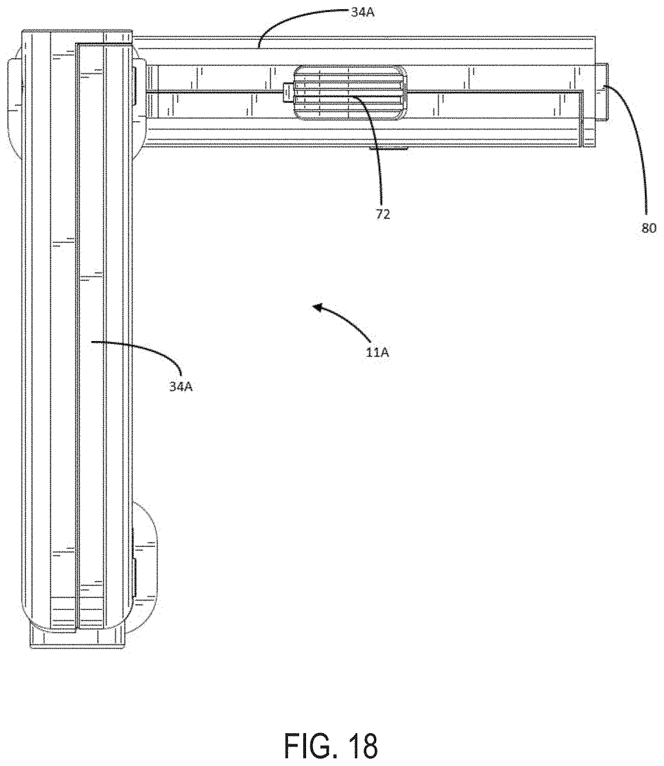

FIG. 18 is one side view of the handle assembly of FIG. 13.

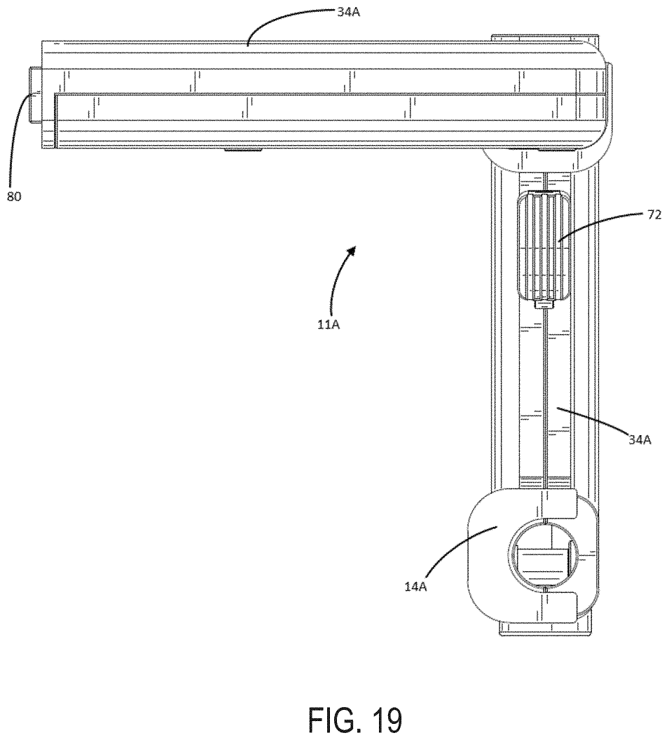

FIG. 19 is an opposite side view of the handle assembly of FIG. 13.

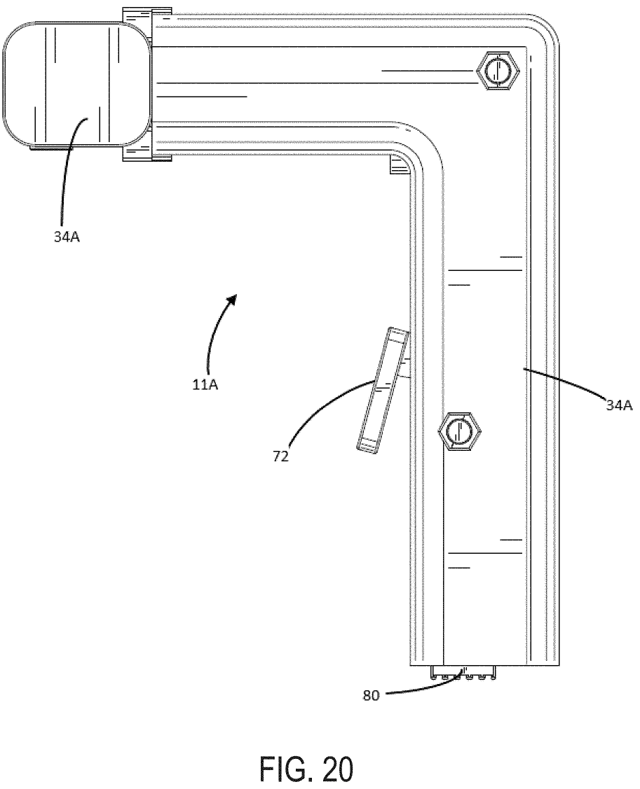

FIG. 20 is a top view of the handle assembly of FIG. 13.

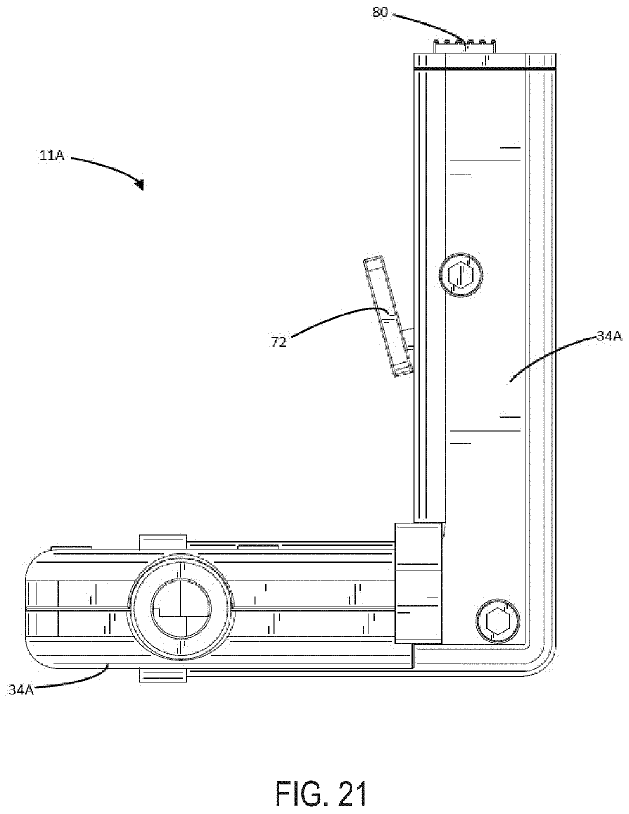

FIG. 21 is a bottom view of the handle assembly of FIG. 13.

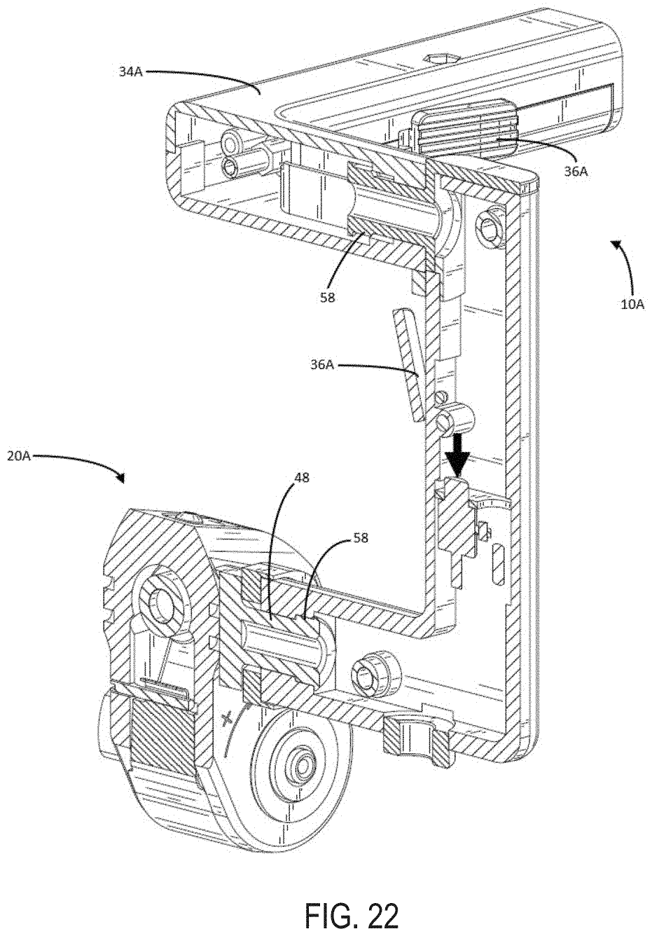

FIG. 22 is a cross-sectional view of the handle assembly of FIG. 13.

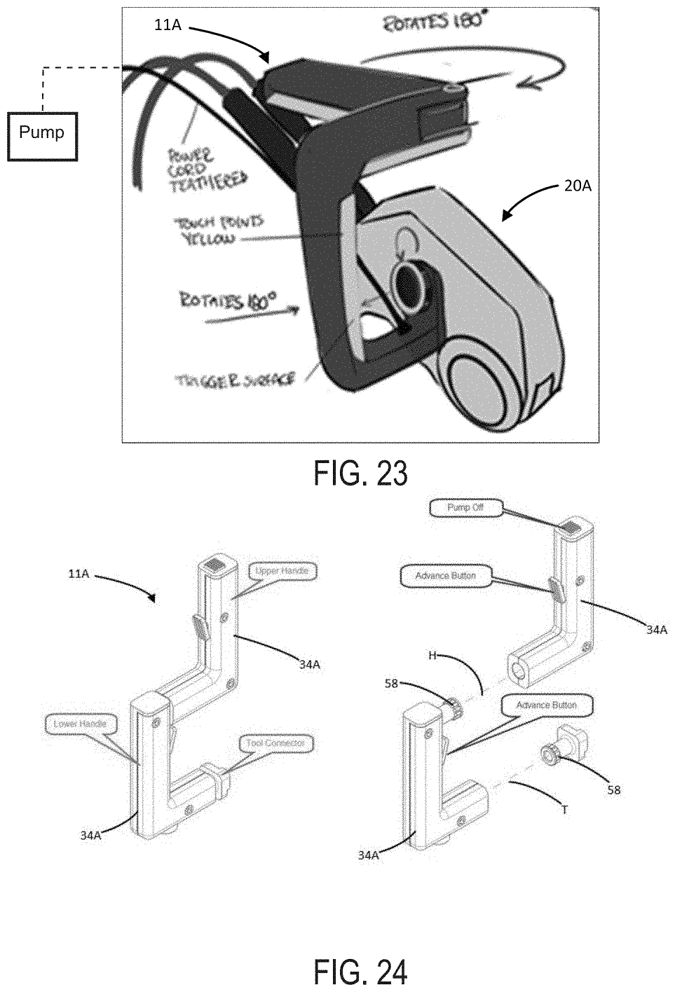

FIG. 23 is a perspective view of another alternative embodiment of a tool, such as a reciprocating piston fluid-operated torque wrench, having integrated controls.

FIG. 24 includes perspective views of the handle assembly of FIG. 8, illustrating assembly and disassembly of the components.

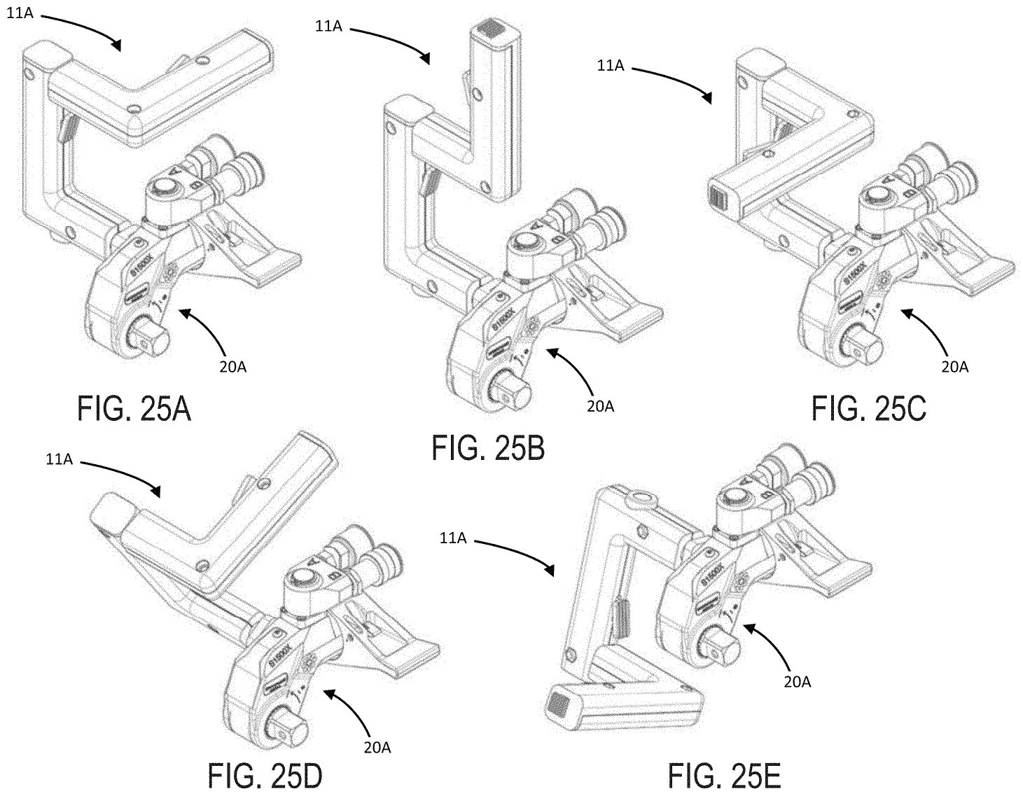

FIGS. 25A-25E are perspective views of the tool and the control assembly of FIG. 8, illustrating different relative pivoted positions of the control assembly and the handle portions.

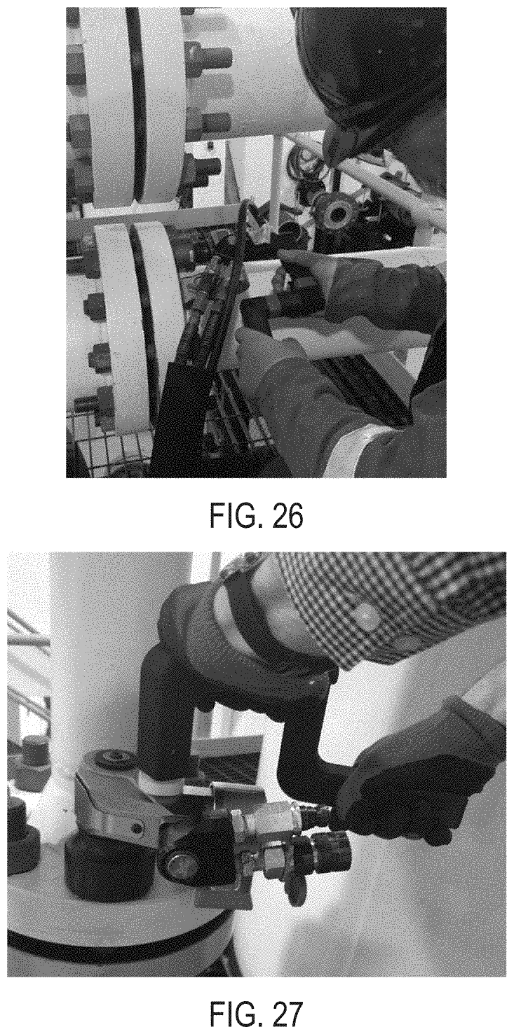

FIG. 26 is a photograph of the tool and the control assembly of FIG. 8, illustrating the tool and the control assembly in use.

FIG. 27 is another photograph of the tool and the control assembly of FIG. 8, illustrating the tool and the control assembly in use.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted”, “connected”, “supported”, and “coupled” and variations thereof are used broadly and encompass both direct and indirect mountings, connections, supports, and couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Referring now to FIGS. 1 and 2, a wrench with selectively integrated controls 10 is provided. The wrench with selectively integrated controls 10 includes a control assembly 11 coupled to a reciprocating piston style torque wrench 20.

The control assembly 11 includes a body 12 having a first end 14 selectively coupled to the wrench 20 and a second end 16 supporting controls 36 for a remotely-located fluid pump (not shown), such as a hydraulic pump.

The torque wrench 20 can be a conventional compact, relatively flat wrench, such as that described in U.S. Pat. Nos. 4,825,730 and 4,982,626, which are hereby incorporated by reference with respect to the construction and operation of a reciprocating piston-style, fluid-operated torque wrench.

As illustrated, the wrench 20 has a housing containing the reciprocating piston drive mechanism (not shown). The housing includes fluid inputs and outputs 22 which fluidly communicate with a remotely-located fluid pump to selectively drive the piston drive mechanism. The wrench 20 further includes a socket 24 on a first end 26 of the tool 20 and a reaction arm 28 on the second end 30 of the tool 20. Although the socket 24 is illustrated as a hexagonal opening, in other embodiments (not shown), the socket can be a driver, such as a square projecting socket driver. However, in low clearance operations, a hexagonal opening is typically utilized.

In conventional operation of the wrench 20, the socket 24 is placed on a nut (not shown) by a first operator with the reaction arm 28 in engagement with a portion of a flange or an adjacent nut (also not shown). Once the wrench 20 is securely in position and the first operator is clear, the second operator actuates the pump remotely to provide fluid to the wrench 20, which drives the drive mechanism, and turns the socket 24 while the reaction arm 28 pushes against the reaction surface. Upon completion of the torque application, the second operator turns the pump off, and the first operator moves the wrench 20 to another nut. This process is then repeated for all nuts on a flange.

As noted above, this can be a cumbersome operation with either two operators or with one operator switching from wrench manipulation to pump control manipulation. Thus, a pump control coupled to the wrench 20 may be desirable to allow single person operation without the need to switch between manipulation of the wrench 20 and the pump or without reliance upon another person. The control assembly 11 provides such operation.

As shown in FIGS. 1 and 2, a control assembly 11 is coupled to the wrench 20. The control assembly 11 is coupled to wrench 20 with a fastener 35 allowing the control assembly 11 to be selectively coupled (and decoupled) to the wrench 20. In the illustrated embodiment, threaded fasteners are used to connect the first end 14 of the body 12 to the wrench 20. In other embodiments (not shown), the control assembly 11 can be permanently coupled to the wrench 20.

In the illustrated embodiment, the control assembly 11 is coupled to the wrench 20 via a first fastener 32, a mounting bracket 33, and second fastener 35. The first fastener 32 connects the mounting bracket 33 to the wrench 20. The second fastener 35 connects the first end of the body 12 to the mounting bracket 33. As illustrated, the second fastener 35 includes a thumb screw allowing for easy user manipulation to selectively remove the control assembly 11 from the wrench 20. In some embodiments, mounting brackets may be sized differently for different wrenches while the interconnection between the control assembly 11 and the bracket 33 is standardized.

FIGS. 3-7 illustrate the control assembly 11 of FIGS. 1 and 2 decoupled from the wrench 20. As shown, the body 12 is generally T-shaped with the bottom of the “T” terminating at the first end 14 and the top of the “T” at the second end 16. As shown, handles 34 can be coupled to the top of the T-shaped body 12 to form gripping surfaces during actuation of the wrench 20.

As best illustrated in FIGS. 3 and 6, the pump controls 36 can be positioned between the two handles 34. The pump controls 36 can include one or more actuators or control members. As shown, the illustrated embodiment includes three buttons 36—one button can be an “on/off” switch to turn the pump on and off, and the other two buttons can be used to control the flow of fluid to the wrench 20. Each button 36 is operable by a digit (e.g., a thumb) on a user's hand. In the illustrated construction, in order to actuate the wrench 20, two control buttons 36 need to be contacted by the operator. Because each button 36 is operated by a user's thumb, each of the operator's hands will be on an adjacent handle 34, clear of any pinch points.

The buttons 36 of the illustrated embodiment are electrically coupled to the pump via wiring (not shown). Wires from the buttons extend through the body 12 to an electrical connection port 38 in the side of body 12. This connection port can be a mounted control cable quick connect. An external wire (not shown) can be connected to the connection port 38 to communicate with the pump. In other embodiments (not shown), wireless communication techniques can also be used.

As shown in FIGS. 3-5, an additional handle 40 is connected to the body 12 of the control assembly 11. This handle 40 extends in a direction that is generally perpendicular to the axis of rotation of the socket 24. This handle 40 can be used to lift and maneuver the wrench 20 without the need to contact the wrench 20 itself, which may eliminate the opportunity for pinch points between the wrench 20 and the items being fastened.

In operation, the wrench and control assembly 10 can be positioned such that the socket 24 is engaged with a nut to be tightened (or loosened). With respect to the illustrated embodiment of FIGS. 1 and 2, the operator can manipulate the wrench 20 into position with at least one hand on the positioning handle 40 and the other hand on the body 12 or control handles 34. Once the socket 24 is positioned on a nut, the operator grips each of the handles 34 and, in this position, can then manipulate the buttons 36 to turn and actuate the pump. This will cause the wrench 20 to turn the nut with the wrench 20 reacting off the reaction surface.

In a preferred method of operation, the operator will need to actuate two buttons 36 at the same time—one with each hand—in order for the pump to provide fluid to the wrench 20. Again, this feature ensures that the operator's hands on the handles 34 and free of pinch points prior to operation of the wrench 20 and the pump. This mode of operation is effective with the control assembly 11 attached to the wrench 20 or detached from the wrench 20 due to space constraints of the fastening location.

Once the actuation cycle is complete, the operator can release the actuation button 36 and actuate the “off” button to turn the pump off. The operator then can grasp the positioning handle 40 to lift the wrench 20 off of the nut being operated on and move the wrench to an adjacent nut. The process above then can be repeated.

FIGS. 8-21 illustrate an alternative construction for controls 110A, including a control assembly 11A, for use with a tool, such as a torque wrench 20A. The control assembly 11A is similar to the control assembly 11 shown in FIGS. 1-7 and described above. Common elements have the same reference number “A.”

As illustrated (see FIGS. 8-12), the tool includes a piston-style torque wrench 20A. In the illustrated construction, the control assembly 11A is mounted on the tool (e.g., on a side of the wrench 20A). In other embodiments (not shown), the control assembly 11A can be mounted to another surface on the wrench 20A, such as, for example, an end surface, a top surface, etc.

The tool generally includes a housing 44, a drive mechanism (e.g., a reciprocating piston drive mechanism) supported by the housing 44 and selectively driven by a power source (e.g., a fluid pump), and an output member (e.g., a socket 24A) driven by the drive mechanism. As illustrated, fluid inputs and outputs 22A on the housing 44 connect the torque wrench 20A to the pump. As illustrated, the wrench 20A includes a first end 26A with the socket 24A and a second end 30A with a reaction arm 28A.

In other constructions (not shown), the tool could be another type of fluid-operated tool or a different type of tool powered by a different power source (e.g., an electrical power source (AC or DC (battery)), a fuel power source (gas engine), etc.). Depending on the type of tool, the tool may include a different type of drive mechanism (e.g., a motor, a transmission, etc.) and a different type of output member (e.g., a bit, a blade, a wheel, etc).

The control assembly 11A has a first end 14A and an opposite, second end 16A and includes a handle assembly with two handle portions 34A. The illustrated control assembly 11A is removably connectable to the housing 44 at the first end 114A. When connected to the tool, the handle assembly is engageable by an operator to move the tool relative to a workpiece (e.g., from bolt to bolt on a flange).

As illustrated, each handle portion 34A is generally L-shaped. The handle portions 34A are relatively movable (e.g., pivotable about a handle axis H). The first handle portion 34A is movably connectable to the tool housing 44 (e.g., pivotable about a tool axis T). In the illustrated construction, the short leg of the first handle portion 34A defines the tool axis T and is movably connected to the tool housing 44, and the short leg of the second handle portion 34A defines the handle axis H and is movably connected to the long leg of the first handle portion 34A. As illustrated, the axes H, T are parallel. In other constructions (not shown), the axes H, T may have a different orientation (e.g., transverse, perpendicular, etc.).

The handle portions 34A have a range of relative pivoting movement, and the handle assembly has a range of pivoting movement relative to the tool. In the illustrated construction, the range is less than 360° (e.g., up to about 180° (as shown), about 270°, about 300°, or about) 320°. The range of movement may be limited by inter-engaging stop surfaces (not shown) on the handle portions 34A or between the handle assembly and the tool to inhibit relative movement beyond certain pivoted positions (e.g., beyond about 0° or beyond about 180°). In other constructions (not shown), the range of movement may be greater (e.g., up to about 360° or more).

In other constructions (not shown), the handle portions 34A may have different relative movement (e.g., rotatable or pivotable about a different axis (see FIG. 23) or more than one axis, sliding movement, combinations). For example, the handle portions 34A could be connected with a U-joint type arrangement or a ball joint. As another example, a handle portion 34A can telescope. Likewise, the connection between the handle assembly and the tool may have different relative movement.

In an alternative construction (see FIG. 23), the L-shaped handle portion(s) 34A can pivot at the intersection of the legs. The illustrated handle portion can pivot about 180° between opposite L-shapes through a flattened condition. However, the handle portions 34A can have a range of motion greater than or less than about 180°.

Locking arrangements 52, 56 are disposed between the handle assembly and the tool and between the handle portions 34A, respectively, to hold the components in selective pivoted positions. Each illustrated locking arrangement 52, 56 includes a positive locking mechanism, such as a detent mechanism with a projection positionable in a selected recess (e.g., recesses provided between teeth 58 on a projection on one handle portion 34A (see FIG. 24)) corresponding to a pivoted position. The projection and recess are biased into engagement (e.g., by a spring). Each locking arrangement 52, 56 may include a frictional locking mechanism, such as a clamp. Each locking arrangement 52, 56 may include a combination positive and frictional locking arrangement.

A connection assembly 48 releasably connects the handle assembly to the tool. As illustrated, the connection assembly 48 includes an adapter 60 connectable between the tool and the handle assembly; however, in an alternative construction (not shown), the handle assembly may be directly connected to the tool housing 44. The adapter 60 includes a connector 64 connectable to the housing 44. The connector 64 may provide a threaded connection (e.g., a threaded shaft threadedly engaging a threaded bore on the housing 44), an interference fit, a bayonet connection, etc. A reaction surface may be provided between the adapter 60 and the tool housing 44,

The adapter 60 includes a connector 68 connectable to the handle assembly. A quick release mechanism on the handle assembly may engage the connector 68. For example, the connector 68 may include an annular groove 70 and the handle assembly may include a movable collar engageable in the groove. The collar may slide laterally at the first end 14A of the handle portion 34A to unblock a bore in the first end 14A, and after the adapter connector 68 is inserted, the collar moves to engage the groove and block the end of the bore. The removal process is reversed. In other constructions (not shown), the connector 68 may provide a different type of connection with the handle assembly, such as, for example, a different quick connection, a threaded connection, an interference fit, a bayonet connection, etc.

In the illustrated construction, pivoting movement between the handle assembly and the tool is accommodated by the adapter 60 (e.g., the pivoting movement is between the handle assembly and the connector 68 of the adapter 60). As illustrated, the adapter 60 allows the handle assembly to pivot about the axis T that extends through the center of the adapter 60. The locking arrangement 52 is provided between the handle assembly and the adapter connector 68 (e.g., a projection selectively engageable in a recess between teeth 58 on the connector 68 (see FIG. 12). In other constructions (not shown), the adapter 60 may accommodate other types of movement with the handle assembly (e.g., rotation or pivoting about a different axis or more than one axis, sliding movement, etc.

The control assembly H A further includes pump controls 36A disposed on the handle portions 34A. In the illustrated construction, a pump control 36A is supported on each handle portion 34A and positioned to be engaged by one or more digits on a separate hand of an operator in order to operate the pump. The pump controls 36A are positioned on the control assembly 11A such that both pump controls 36A cannot be operated by only one hand. The pump controls 36A thus operate to sense one hand of the operator on one handle portion 34A and the other hand of the operator on the other handle portion 341.

The pump controls 36A control the pump to drive the drive mechanism and thereby the output member (the socket 24). The pump controls 36A are in communication with the pump when the handle assembly is connected to the tool housing 44 and when the handle assembly is disconnected from the tool housing 44. The pump is operable under the control of the pump controls 36A when the handle assembly is connected to the tool housing 44 and when the handle assembly is disconnected from the tool housing 44.

Each pump control 36A includes (see FIG. 22) a switch and an actuator engagable by the operator to operate the switch. As an actuator, a pump control 36A includes a button, a lever (as shown), a trigger, a sensor (e.g., pressure, force, displacement, capacitive touch, etc.), etc. The pump controls 36A send control signals to the pump, and the type of control signals depends on, for example, the switch, the power source (e.g., the pump), the drive mechanism of the tool, relative movement between the components (e.g., between the handle assembly and the tool 20A, between the handle portions 34A and the supported switches), etc.

In some constructions (see FIGS. 8-11), the control signals include pneumatic signals, and each switch of a pump control 36A includes an air switch. A conduit 76 (e.g., a 4 mm hose) communicates the signals from the control assembly 11A to the pump.

In other constructions (see FIG. 23), the control signals include electrical signals, and each switch of a pump control 36A includes an electrical switch in communication with the pump. Communication of the control signals from the control assembly 11A to the pump is provided by an electrical conductor (e.g., one or more wires (as shown), a sliding electrical contact, etc.). In other constructions, communication may be wireless, and the control assembly 11A may include a wireless interface.

The illustrated pump controls 36A include two operation levers 72 (e.g., advance controls) and a reset button 80 (e.g., a pump off/on). Each handle portion 34A includes one lever 72, and the levers 72 are operable through the switches to actuate the pump. As shown, the levers 72 are arranged on the handle assembly such that, in the different pivoted positions of the handle portions 34A, the levers 72 cannot both be actuated with one hand of the operator. The illustrated levers 72 are arranged in parallel planes. The reset button 80 is operable to reset the pump and is positioned on the free end of the handle assembly.

Although the invention has be described in detail with reference to certain preferred embodiments, variations and modifications exist within the scope and spirit of one or more independent aspects of the invention as described above. For example, the illustrated embodiment utilizes two-button control to ensure both hands are free of pinch points. In other embodiments, one or more sensors (e.g., capacitive touch sensors, dead man's switches, etc.) can be incorporated into each handle to ensure both hands are free from pinch points prior to actuation of the wrench.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

One or more independent features and/or independent advantages of the invention may be set forth in the following claims:

What is claimed is:

1. A control assembly for a fluid-operated tool, the tool including a housing, and a drive mechanism supported by the housing, the drive mechanism being selectively-driven by a fluid pump and operable to drive an output member, the assembly comprising:
a handle assembly including a first handle portion and a second handle portion, the handle assembly being removably connectable to the housing; and
pump controls operable to control the pump to drive the drive mechanism and thereby the output member, the pump controls including
a first pump control operable by a digit of an operator's first hand on the first handle portion, the first pump control being in communication with the pump when the handle assembly is connected to the housing and when the handle assembly is disconnected from the housing, and
a second pump control operable by a digit of the operator's second hand on the second handle portion, the second pump control being in communication with the pump when the handle assembly is connected to the housing and when the handle assembly is disconnected from the housing;
wherein operation of the pump requires the operator's first hand on the first handle portion and the operator's second hand on the second handle portion; and
wherein the pump is operable under the control of the pump controls to drive the drive mechanism when the handle assembly is connected to the housing and when the handle assembly is disconnected from the housing.

2. The assembly of claim 1, wherein the first handle portion is movably connected to the second handle portion.

3. The assembly of claim 2, wherein the first handle portion is pivotable relative to the second handle portion.

4. The assembly of claim 2, wherein the handle assembly further includes a locking assembly operable to selectively retain the first handle portion in a first position and in a different, second position relative to the second handle portion.

5. The assembly of claim 1, wherein each of the first handle portion and the second handle portion has a generally L-shape.

6. The assembly of claim 1, wherein each pump control includes a switch and an actuator engageable by a digit of an operator's hand to operate the switch.

7. The assembly of claim 6, wherein the switch includes an air switch, and wherein the pump controls further include a conduit connecting the air switch to the pump.

8. The assembly of claim 6, wherein the switch includes an electrical switch, the electrical switch being in communication with the pump.

9. The assembly of claim 8, wherein the pump controls further includes an electrical conductor electrically connecting the electrical switch with the pump.

10. The assembly of claim 8, wherein the pump controls further includes a wireless interface communicating between the electrical switch and the pump.

11. A tool comprising:
a housing;
a drive mechanism supported by the housing, the drive mechanism being selectively-driven by a fluid pump and operable to drive an output member; and
a control assembly including
a handle assembly including a first handle portion and a second handle portion, the handle assembly being removably connectable to the housing, and
pump controls operable to control the pump to drive the drive mechanism and thereby the output member, the pump controls being in communication with the pump when the handle assembly is connected to the housing and when the handle assembly is disconnected from the housing, the pump controls including
a first pump control supported proximate the first handle portion, the first pump control being operable by a digit of a first hand of an operator gripping the first handle portion, and
a second pump control supported proximate the second handle portion, the second pump control being operable by a digit of a second hand of the operator on the second handle portion;
wherein operation of the pump requires the operator's first hand on the first handle portion and the operator's second hand on the second handle portion; and
wherein the pump is operable under the control of the pump controls to drive the drive mechanism when the handle assembly is connected to the housing and when the handle assembly is disconnected from the housing.

12. The tool of claim 11, wherein the first handle portion is movably connected to the second handle portion.

13. The tool of claim 12, wherein the first handle portion is pivotable relative to the second handle portion.

14. The tool of claim 12, wherein the handle assembly further includes a locking assembly operable to selectively retain the first handle portion in a first position and in a different, second position relative to the second handle portion.

15. The tool of claim 11, wherein the handle assembly is movably connected to the housing.

16. The tool of claim 15, wherein the handle assembly is pivotable relative to the housing.

17. The tool of claim 15, wherein the handle assembly further includes a locking assembly operable to selectively retain the handle assembly in a first position and in a different, second position relative to the housing.

18. The tool of claim 11, wherein each pump control includes a switch and an actuator engageable by a digit of an operator's hand to operate the switch.

19. The tool of claim 11, further comprising an adapter connectable between the handle assembly and the housing.

20. A method of operating a fluid-operated tool, the tool including a housing and a drive mechanism supported by the housing and operable to drive an output member, the method comprising:
providing a control assembly including a handle assembly separate from the housing, the handle assembly including a first handle portion and a second handle portion;
selectively and alternatively releasably connecting the handle assembly to the housing and disconnecting the handle assembly from the housing;
positioning the output member relative to a fastener to be adjusted;
when the handle assembly is connected to the housing, after positioning, operating a fluid pump to drive the drive mechanism and thereby the output member, operating including sensing the operator's first hand on the first handle portion while sensing the operator's second hand on the second handle portion; and
when the handle assembly is disconnected from the housing, after positioning, operating the fluid pump to drive the drive mechanism and thereby the output member, operating including sensing the operator's first hand on the first handle portion while sensing the operator's second hand on the second handle portion.

21. The method of claim 20, wherein sensing includes operating a pump control with a digit of an operator's hand.

22. The method of claim 20, further comprising, before operating, movably adjusting the first handle portion relative to the second handle portion from a first position to a second position, the fluid pump being operable when the handle assembly is connected to the housing with the first handle portion in the first position and with the first handle position in the second position.
